(19) United States
(12) Patent Application Publication
(10) Pub. No.: US 2023/0163962 A1
(43) Pub. Date: May 25, 2023

(54) ENTROPY DISTRIBUTION

(71) Applicant: Cryptography Research, Inc., San Jose, CA (US)

(72) Inventors: Winthrop Wu, Pleasanton, CA (US); Scott C. Best, Palo Alto, CA (US)

(21) Appl. No.: 17/989,594

(22) Filed: Nov. 17, 2022

Related U.S. Application Data
(60) Provisional application No. 63/282,134, filed on Nov. 22, 2021.

(51) Int. Cl. H04L 9/08; H04L 9/00

(52) U.S. Cl. CPC H04L 9/0869; H04L 9/003; H04L 9/0822

(57) ABSTRACT

Technologies for selectively distributing a same random number to multiple cryptographic circuits are described. One apparatus includes a plurality of cryptographic circuits. Each of the plurality of cryptographic circuits is to receive a random number for differential power analysis (DPA) protection of a cryptographic operation. At least two of the plurality of cryptographic circuits are configured to selectively use a same random number.

### RELATED APPLICATIONS

This application claims the benefit of U.S. Provisional Application No. 63/282,134, filed Nov. 22, 2021, the entire contents of which are incorporated by reference.

### BACKGROUND

Cryptographic circuits that perform cryptographic operations are susceptible to side-channel attacks where an attacker may obtain sensitive data as the cryptographic operation is performed. One type of side-channel attack is Differential Power Analysis (DPA), where the attacker who seeks to obtain a secret key used in a cryptographic operation may study the differences in power consumption of an integrated circuit as the cryptographic operation is performed. An attacker may be an unauthorized entity that may obtain the secret key information associated with the cryptographic operation by analyzing power consumption measurements of the integrated circuit over a period of time. So, in order to secure cryptographic operations, random material (such as masks, nonces, an initialization vector (IV), key-wrapping keys, etc.) can be used with input data being processed by the cryptographic operation to obfuscate the computation or otherwise conceal the secret key information. The random material can be generated from an entropy source. Entropy is a measurement of uncertainty, disorder, or unpredictability in a system and the higher the entropy, the higher the uncertainty found in a result. An entropy source can be any type of unpredictable noise source, such as hardware sources like variance in fan noise, mouse movements, or other randomness generators. A circuit can collect or measure the randomness of the noise source and generate a random number (entropy output) based on the randomness of the noise source. Random number generators (RNGs) are hardware devices that take non-deterministic inputs from the noise source and generate unpredictable numbers as their outputs. The higher the entropy of the RNG, the less certainty (i.e. higher unpredictability) is found in the result.

Modern systems may require multiple secure cryptographic operations. Scaling the number of cryptographic operations performed increases the demand for random numbers, which can exceed a rate at which random numbers can be generated and distributed by an RNG. In particular, it will take an RNG some period of time in order to produce and deliver a random number for a single request. When multiple requests are submitted to a centralized random number generation block for servicing, as the number of requests increases, so does the overall time required to service all the requests. This interval can grow to the point where the requests are stalled beyond an acceptable period of time or possibly produce an incorrect result.

### BRIEF DESCRIPTION OF THE DRAWINGS

The present disclosure is illustrated by way of example, and not by way of limitation, in the figures of the accompanying drawings.

FIG. 1A is a block diagram of a random number generator that services requests for random numbers from multiple consumers over direct connections, according to one implementation.

FIG. 1B is a block diagram of a random number generator that services requests for random numbers from multiple consumers over a common connection, according to one implementation.

FIG. 2A is a block diagram of a random number generator with entropy distribution logic that services requests for random numbers from multiple consumers over direct connections, according to at least one embodiment.

FIG. 2B is a block diagram of a random number generator with entropy distribution logic that services requests for random numbers from multiple consumers over a common connection, according to at least one embodiment.

FIG. 3 is a block diagram of a random number generator with entropy distribution logic, according to at least one embodiment.

FIG. 4 is a block diagram of a random number generator with entropy distribution logic, according to at least one embodiment.

FIG. 5 is a block diagram of an integrated circuit with an entropy source and multiple cryptographic circuits, according to at least one embodiment.

FIG. 6 is a block diagram of an integrated circuit with an entropy source and multiple cryptographic circuits, according to at least one embodiment.

FIG. 7 is a flow diagram of a method for selectively providing a shared random number to multiple cryptographic circuits, according to at least one embodiment.

FIG. 8 is a flow diagram of a method for selectively providing a shared random number to multiple cryptographic circuits and a non-shared random number to a single cryptographic circuit, according to at least one embodiment.

### DETAILED DESCRIPTION

The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

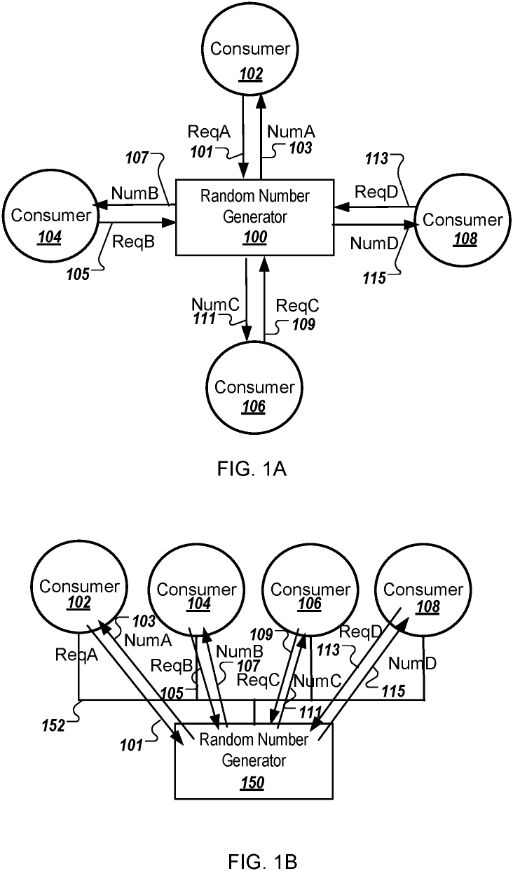

FIG. 1A is a block diagram of a random number generator (RNG) 100 that services requests for random numbers from multiple consumers over direct connections, according to one implementation. The RNG 100 receives a first request 101 from a first consumer 102. The first consumer 102 can be a first cryptographic circuit or a first cryptographic operation. The RNG 100 generates a first random number 103 and provides the first random number 103 to the first consumer 102 in response to the first request 101. The RNG 100 can also receive a second request 105 from a second consumer 104. The second consumer 104 can be a second cryptographic circuit different from the first cryptographic circuit or a second cryptographic operation different from the first cryptographic operation. The RNG 100 generates a second random number 107 and provides the second random number 107 to the second consumer 104 in response to the second request 105. The RNG 100 can also receive a third request 109 from a third consumer 106. The third consumer 106 can be a third cryptographic circuit different from the other cryptographic circuits or a third cryptographic operation different from the other cryptographic operations. The RNG 100 generates a third random number 111 and provides the third random number 111 to the third consumer 106 in response to the third request 109. The RNG 100 can also receive a fourth request 113 from a fourth consumer 108. The fourth consumer 108 can be a fourth cryptographic circuit different from the other cryptographic circuits or a fourth cryptographic operation different from the other cryptographic operations. The RNG 100 generates a fourth random number 115 and provides the fourth random number 115 to the fourth consumer 108 in response to the fourth request 113.

The RNG 100 is a centralized RNG that is operatively coupled with a plurality of consumers. In one embodiment, it receives requests over direct connections with the consumers in this implementation. The RNG 100 can receive requests over a common connection in other implementations, as illustrated in FIG. 1B.

FIG. 1B is a block diagram of a random number generator (RNG) 150 that services requests for random numbers from multiple consumers over a common connection 152, according to one implementation. The RNG 150 operates similarly to the RNG 100 described above, except the requests and random numbers are sent over the common connection 152 (e.g., a multi-drop bus, a multi-client interface, or other techniques familiar to those skilled in the art).

As described above, scaling the number of cryptographic operations performed increases the demand for random numbers, which can exceed a rate at which random numbers can be generated and distributed by the RNG 100 or RNG 150. A circuit can be designed to include additional RNGs to accommodate the increase in the number of cryptographic operations expected. However, the additional RNGs are expensive in chip area and increase design complexity. Also, the demand can increase beyond the rate at which the additional RNGs can generate and distribute the random numbers.

Aspects of the present disclosure of embodiments can overcome the challenges described above and others by providing cryptographic circuits that can be selectively operated to use a same random number. Aspects of the present disclosure of embodiments can decouple the demand for random numbers from the number of cryptographic operations being performed. Aspects of the present disclosure of embodiments can provide a centralized generation scheme to support multiple consumers of random material, while achieving an area savings over a distributed generation scheme. Aspects of the present disclosure of embodiments can achieve scalable generation and distribution of random materials (e.g., masks, nonces, key-wrapping keys, etc.) by replicating and re-using the random materials. Aspects of the present disclosure of embodiments can reduce the overall time required to service all the requests. The number of requests increases when at least some random numbers generated can be shared among multiple cryptographic operations. Aspects of the present disclosure of embodiments can reduce or prevent requests from being stalled beyond the acceptable period of time or producing an incorrect result.

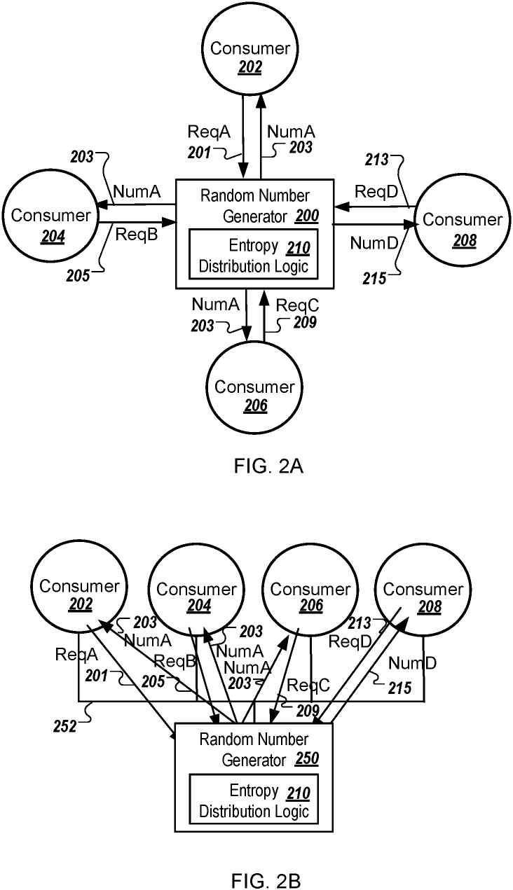

FIG. 2A is a block diagram of a random number generator (RNG) 200 with entropy distribution logic 210 that services requests for random numbers from multiple consumers operatively coupled via direct connections, according to at least one embodiment. The entropy distribution logic 210 can determine whether requests for random numbers from different consumers can use (i.e., reuse, or share) the same random number. In at least one embodiment, the entropy distribution logic 210 can determine which consumers requested a shared random number or a non-shared random number. This assumes that the random number for different cryptographic operations can be shared. The RNG 200 can produce a single random number, distribute a single random number to all requests for a shared random number, and produce and distribute a non-shared random number to each request for a non-shared random number. The non-shared random number can be a unique random number for the requesting consumer. Based on the amount of sharing allowed, the entropy distribution logic 210 can centralize the generation and distribution of random material and decouple the demand for random material from the number of requestors.

The RNG 200 receives a first request 201 from a first consumer 202. The first consumer 202 can be a first cryptographic circuit (e.g., a processing circuit configured to perform a cryptographic operation) performing a first cryptographic operation. The entropy distribution logic 210 can determine that the first request 201 is for a shared random number. The RNG 200 generates a first random number 203 and provides the first random number 203 to the first consumer 202 in response to the first request 201.

The RNG 200 can also receive a second request 205 from a second consumer 204. The second consumer 204 can be a second cryptographic circuit (e.g., a processing circuit configured to perform a cryptographic operation) different from the first cryptographic circuit performing a second cryptographic operation different from the first cryptographic operation. The entropy distribution logic 210 can determine that the second request 205 is for a shared random number. So, instead of generating a second random number for the second request 205, the RNG 200 provides the first random number 203 to the second consumer 204 in response to the second request 205.

The RNG 200 can also receive a third request 209 from a third consumer 206. The third consumer 206 can be a third cryptographic circuit (e.g., a processing circuit configured to perform a cryptographic operation) different from the other cryptographic circuits performing a third cryptographic operation different from the other cryptographic operations. The entropy distribution logic 210 can determine that the third request 209 is for a shared random number. So, instead of generating a third random number for the third request 209, the RNG 200 provides the first random number 203 to the third consumer 206 in response to the third request 209.

The RNG 200 can also receive a fourth request 213 from a fourth consumer 208. The fourth consumer 208 can be a fourth cryptographic circuit (e.g., a processing circuit configured to perform a cryptographic operation) different from the other cryptographic circuits performing a fourth cryptographic operation different from the other cryptographic operations. The entropy distribution logic 210 can determine that the fourth request 213 is for a non-shared random number. So, the RNG 100 generates a second random number 215 and provides the second random number 215 to the fourth consumer 208 in response to the fourth request 213.

In this embodiment, the RNG 200 is a centralized RNG that receives requests over direct (e.g., point to point) connections with the consumers it is operatively coupled with. An RNG can receive requests over a common connection (e.g., point to multi-point) in other embodiments, such as illustrated in FIG. 2B.

FIG. 2B is a block diagram of a random number generator (RNG) 250 with entropy distribution logic 210 that services requests for random numbers from multiple consumers over a common connection, according to at least one embodiment. The RNG 250 and entropy distribution logic 210 operate similarly to the RNG 200 and entropy distribution logic 210 as described above, except the requests and random numbers are sent over the common connection 252.

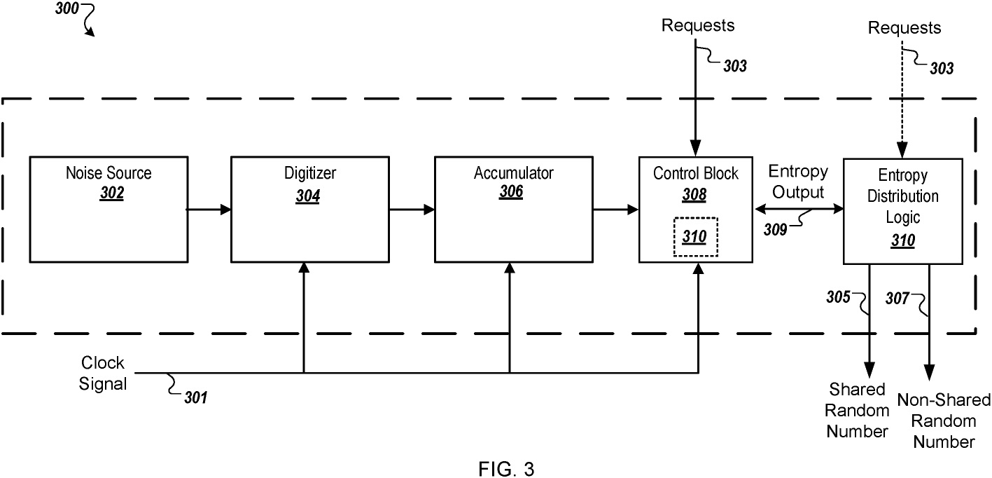

FIG. 3 is a block diagram of a random number generator (RNG) 300 with entropy distribution logic 310, according to at least one embodiment. The RNG 300 includes a noise source 302, a digitizer 304, an accumulator 306, a control block 308, and the entropy distribution logic 310. In at least one embodiment, the noise source 302 is an analog noise source that produces a random analog signal. The digitizer 304 measures the random analog signal to produce a digital value. The digital value can be a single bit or multiple bits. The digitizer 304 can use a clock signal 301 to sample the random analog signal to produce a digital bitstream that is output to the accumulator 306. The accumulator 306 can receive the digital bitstream and produce a random number of a specified size. The accumulator 306 can use the clock signal 301 to synchronize operations of a digital circuit that combines the current output of the digitizer with accumulated values derived from previous outputs of the digitizer, and in this way generate the random number. In some embodiments (e.g., as specified by NIST standard SP-800 90A) the accumulator itself performs cryptographic processing as part of the accumulation function. The control block 308 can receive one or more requests 303 from one or more cryptographic circuits or cryptographic operations. The one or more requests 303 can be for shared random numbers or non-shared random numbers as described herein. The control block 308 can process the incoming requests 303 and determine an overall request for random numbers and how to address the incoming requests 303. The control block 308 can determine whether multiple requests 303 from different cryptographic circuits or operations can use the same random number. For example, the control block 308 can be configured to operate such that it allows random numbers to be shared as long as the different cryptographic circuits are performing different cryptographic algorithms. The control block 308 can determine whether one or more requests 303 are for unique random numbers that are not shareable. The control block 308 can arbitrate the incoming requests 303 for random numbers accordingly and provide one or more random numbers as entropy output 309 to the entropy distribution logic 310. The entropy distribution 310 can distribute the random numbers to the requesting cryptographic circuits or cryptographic operations as instructed by the control block 308. That is, the entropy distribution 310 can deliver a shared random number where the incoming requests specified that the random number can be shared. The entropy distribution 310 can also deliver a non-shared number to only the requesting cryptographic circuit or operation where the incoming request specifies that the random number cannot be shared. Based upon the amount of sharing allowed, the control block 308 can provide centralized generation and distribution of random numbers and decouple the demand for random numbers in the requests 303 from a number of requesting cryptographic circuits or operations.

In another embodiment, the entropy distribution logic 310 can receive one or more requests 303 (illustrated as dashed lines) from one or more cryptographic circuits or cryptographic operations. The one or more requests 303 can be for shared random numbers or non-shared random numbers as described herein. The entropy distribution logic 310 can determine whether multiple requests 303 from different cryptographic circuits or operations can use the same random number. For example, the entropy distribution logic can be configured to operate such that it allows random numbers to be shared as long as the different cryptographic circuits are performing different cryptographic algorithms. The entropy distribution logic 310 can determine whether one or more requests 303 are for unique random numbers that are not shareable. In at least one embodiment, the entropy distribution logic 310 can send one of the incoming requests to the control block 308 to receive a single random number from the control block 308 and distribute the single random number as a shared random number 305 to the requesting cryptographic circuits or operations where the same random number can be used. The entropy distribution logic 310 can receive a non-shared random number from the control block 308 for each requesting cryptographic circuit or operation where the non-shared random number is not shareable and can distribute a non-shared random number 307 to the respective cryptographic circuit or operation. Based upon the amount of sharing allowed, the entropy distribution logic 310 can provide centralized generation and distribution of random numbers and decouple the demand for random numbers in the requests 303 from a number of requesting cryptographic circuits or operations.

In another embodiment, the accumulator 306 could take the output of the digitizer 304 (Entropy output) and eventually generate a random number. This could be delivered to the entropy distribution logic 310 in response to a request from the entropy distribution logic 310 based upon the incoming requests without the control block 308. In another embodiment, when the control block 308 is present, the control block 308 can interact with the accumulator 306 to retrieve a random number and deliver the random number and the distribution information to the entropy distribution logic 310.

In another embodiment, the functionality of the entropy distribution logic 310 can be integrated into the control block 308 as illustrated in the dashed box of control block 308. In this embodiment, the control block 308 receives the multiple requests 303 from different cryptographic circuits or operations and provides either a shared random number 305 or a non-shared random number 307 based on whether the cryptographic circuit or operation can share the random number.

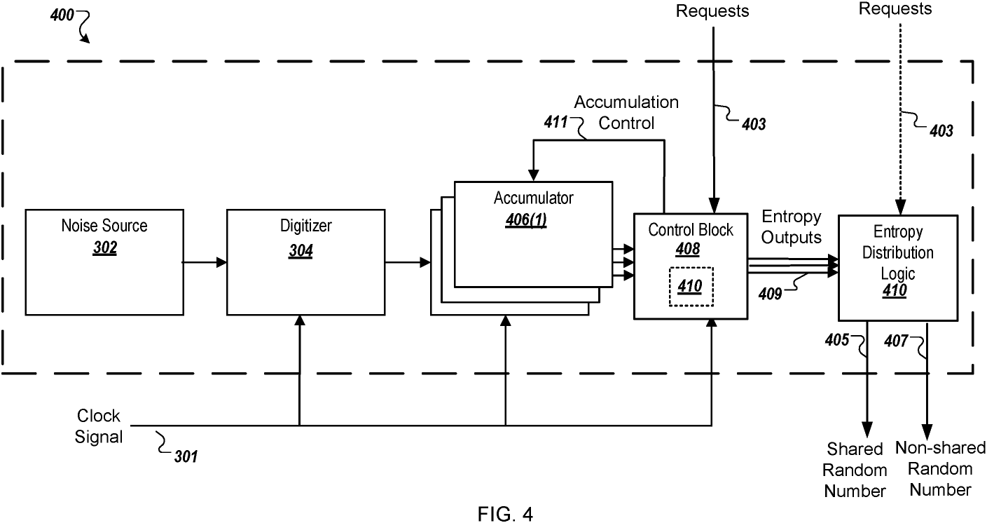

FIG. 4 is a block diagram of a random number generator (RNG) 400 with entropy distribution logic 410, according to at least one embodiment. The RNG 400 is similar to RNG 300 as noted by similar reference numbers, except the RNG 400 includes multiple accumulators 406(1)-(N), where N is a positive integer larger than 1. Each of the multiple accumulators 406(1)-(N) are functionally similar to accumulator 306 described above (e.g., each may be designed according to NIST specification SP800-90A) and each can provide a random number. The control block 408 can receive one or more requests 403 from one or more cryptographic circuits or cryptographic operations. The one or more requests 403 can be for shared random numbers or non-shared random numbers as described herein. The control block 408 can process the incoming requests 403 and determine an overall request for random numbers and how to address the incoming requests 403. The control block 408 can determine whether multiple requests 403 from different cryptographic circuits or operations can use the same random number. For example, the control block 408 can be configured to operate such that it allows random numbers to be shared as long as the different cryptographic circuits are performing different cryptographic algorithms. The control block 408 can determine whether one or more requests 403 are for unique random numbers that are not shareable. The control block 408 can multiplex the incoming requests 403 for random numbers accordingly and provide one or more random numbers as entropy output 409 to the entropy distribution logic 410. The control block 408 can also control the accumulators 406(1)-(N) using one or accumulation control signals 411. The entropy distribution logic 410 can distribute the random numbers to the requesting cryptographic circuits or cryptographic operations as instructed by the control block 408. That is, the entropy distribution logic 410 can deliver a shared random number where the incoming requests specified that the random number can be shared. The entropy distribution logic 410 can also deliver a non-shared number to only the requesting cryptographic circuit or operation where the incoming request specifies that the random number cannot be shared. Based upon the amount of sharing allowed, the control block 408 can provide centralized generation and distribution of random numbers and decouple the demand for random numbers in the requests 403 from a number of requesting cryptographic circuits or operations. Based upon the amount of sharing allowed, the control block 408 can provide centralized generation and distribution of random numbers and decouple the demand for random numbers in the requests 403 from a number of requesting cryptographic circuits or operations.

In another embodiment, the entropy distribution logic 410 is similar to the entropy distribution logic 310. The entropy distribution logic 410 receives multiple requests 403 (illustrated as dashed lines) and provides either a shared random number 405 or a non-shared random number 407 based on whether the cryptographic circuit or operation can share the random number. Based upon the amount of sharing allowed, the entropy distribution logic 410 can provide centralized generation and distribution of random numbers and decouple the demand for random numbers in the requests 403 from a number of requesting cryptographic circuits or operations.

In another embodiment, the functionality of the entropy distribution logic 410 can be integrated into the control block 408 as illustrated in the dashed box of control block 408. In this embodiment, the control block 408 receives the multiple requests 403 from different cryptographic circuits or operations and provides either a shared random number 405 or a non-shared random number 407 based on whether the cryptographic circuit or operation can share the random number. In another embodiment, the RNG 400 can operate without the control block 408 and the functionality of the control block 408 can be implemented with the entropy distribution logic 410 as described above.

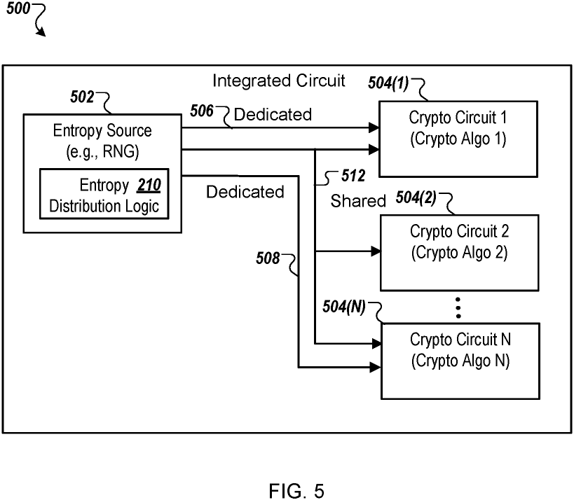

FIG. 5 is a block diagram of an integrated circuit 500 with an entropy source 502 and multiple cryptographic circuits 504, according to at least one embodiment. The entropy source 502 includes entropy distribution logic 210. The entropy source 502 is operatively coupled to a first cryptographic circuit 504(1) via a first dedicated (e.g., point-to-point) connection 506. The first dedicated connection 506 can be a dedicated communication path. The first cryptographic circuit 504(1) implements a first cryptographic algorithm that needs a non-shared random number (e.g., a unique random number) in a first instance. The entropy source 502 can provide a non-shared random number to the first cryptographic circuit 504(1) over the first dedicated connection 506 for the first cryptographic operation. The first cryptographic operation 504(1), at a second instance, can implement a first cryptographic operation (or another cryptographic operation) for which a shared random number can be used. The entropy source 502 can provide the shared random number to the first cryptographic circuit 504(1) over a shared (e.g., point to multi-point) connection 512 for the first cryptographic operation (or the other cryptographic operation). The shared connection 512 can be multiple communication paths that share a common origin at the entropy source 502.

In the illustrated embodiment, the entropy source 502 is coupled to a second cryptographic circuit 504(2) via the shared connection 512. In this embodiment, the second cryptographic circuit 504(2) is only coupled to the entropy source 502 via the shared connection 512. In other embodiments, the second cryptographic circuit 504(2) can be coupled to the entropy source 502 via a dedicated connection. The second cryptographic circuit 504(2) implements a second cryptographic algorithm that can use a shared random number. The entropy source 502 can provide the shared random number to the second cryptographic circuit 504(2) over the shared connection 512 for the second cryptographic operation.

In the illustrated embodiment, the entropy source 502 is coupled to additional cryptographic circuits, including an Nth cryptographic circuit 504(N) via the shared connection 512 and an Nth dedicated connection 508, where N is a positive integer greater than two. The Nth dedicated connection 508 can be a dedicated communication path. In this embodiment, the Nth cryptographic circuit 504(N) is only coupled to the entropy source 502 via the shared connection 512. The Nth cryptographic circuit 504(N) implements an Nth cryptographic algorithm that needs a non-shared random number (e.g., a unique random number) in a first instance. The entropy source 502 can provide a non-shared random number to the Nth cryptographic circuit 504(N) over the Nth dedicated connection 508 for the Nth cryptographic operation. The Nth cryptographic operation 504(N), at a second instance, can implement an Nth cryptographic operation (or another cryptographic operation) for which a shared random number can be used. The entropy source 502 can provide the shared random number to the Nth cryptographic circuit 504(N) over the shared connection 512 for the Nth cryptographic operation (or the other cryptographic operation).

In at least one embodiment, the entropy distribution logic 210 can determine whether a request is for a non-shared unique random number or a shared random number based on the type of connection from which the request was received. For example, a request for a non-shared random number for the first cryptographic circuit 504(1) can come over the first dedicated connection 506, and a request for a shared random number can come over the shared connection 512. In another embodiment, the entropy distribution logic 210 can receive a request that specifies the requirement of a non-shared random number or a shared random number. In another embodiment, the entropy distribution logic 210 can receive an indication of the requirement in a side-band communication, a stored profile, or from a specified type of cryptographic operation being performed by the requesting cryptographic circuit.

In at least one embodiment, any of the N cryptographic circuits 504(1)-(N) can have both a dedicated connection and a shared connection. In at least one embodiment, any of the N cryptographic circuits 504(1)-(N) can have only a dedicated connection or a shared connection. In other embodiments, any of the N cryptographic circuits 504(1)-(N) can implement more than one cryptographic operation.

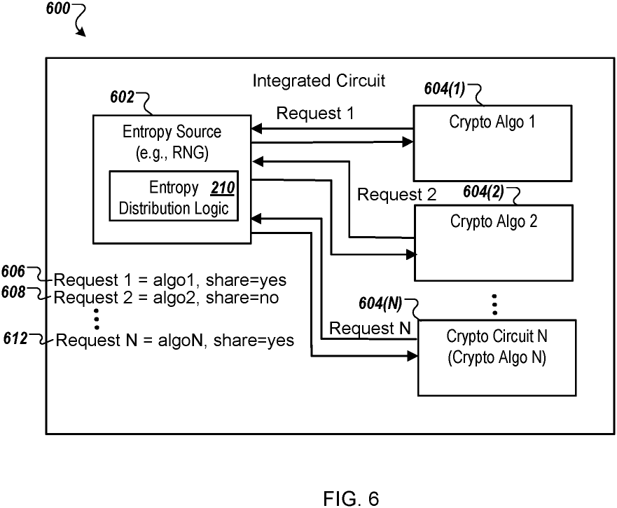

FIG. 6 is a block diagram of an integrated circuit 600 with an entropy source and multiple cryptographic circuits 604, according to at least one embodiment. The entropy source 602 includes entropy distribution logic 210 that receives requests from N cryptographic circuits 604(1)-(N). The cryptographic circuits 604(1)-(N) can be operationally coupled to the entropy sources 602 in various manners. In this embodiment, each of the requests includes a parameter that specifies whether the random number can be a shared random number. The entropy distribution logic 210 can receive a first request 606 from a first cryptographic algorithm implemented on a first cryptographic circuit 604(1). The first request 606 includes a parameter that indicates that the random number requested can be a shared random number (e.g., share=yes). The entropy distribution logic 210 can receive a second request 608 from a second cryptographic algorithm implemented on a second cryptographic circuit 604(2). The second request 608 includes a parameter that indicates that the random number requested cannot be a shared random number (e.g., share=no). This means that the second cryptographic circuit 604(2) requires a non-shared random number (e.g., a unique random number). The entropy distribution logic 210 can receive an Nth request 612 from an Nth cryptographic algorithm implemented on an Nth cryptographic circuit 604(N). The Nth request 612 includes a parameter that indicates that the random number requested can be a shared random number (e.g., share=yes). In this case, the first cryptographic circuit 604(1) and the Nth cryptographic circuit 604(N) are provided with the same random number.

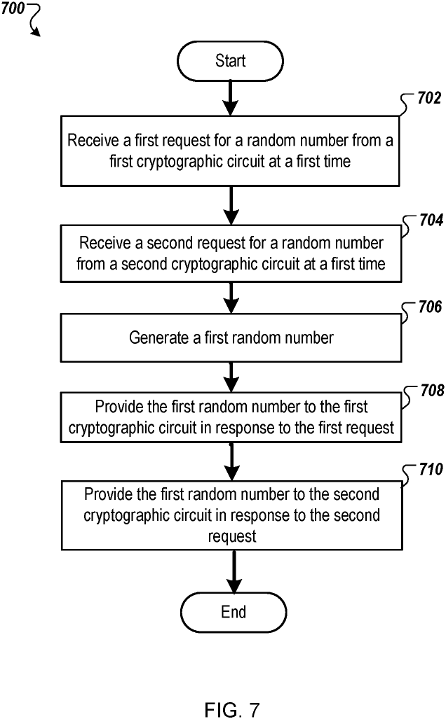

FIG. 7 is a flow diagram of a method 700 for selectively providing a shared random number to multiple cryptographic circuits, according to at least one embodiment. The method 700 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 700 is performed by the random number generator 200 or 250 of FIGS. 2A or 2B. In one embodiment, the method 700 is performed by the entropy distribution logic 210 of FIGS. 2A, 2B, 5, or 6. In one embodiment, the method 700 is performed by entropy distribution logic 310 of FIG. 3 or the entropy distribution logic 410 of FIG. 4. In one embodiment, the method 700 is performed by entropy source 502 or integrated circuit 500 of FIG. 5. In one embodiment, the method 700 is performed by entropy source 602 or integrated circuit 600 of FIG. 6.

Referring to FIG. 7, the method 700 begins by the processing logic receiving, at a first time, a first request for a random number from a first cryptographic circuit (block 702). The processing logic receives, at the first time, a second request for a random number from a second cryptographic circuit (block 704). The processing logic generates a first random number (block 706). The processing logic generates a first random number (block 708). The processing logic provides the first random number to the first cryptographic circuit in response to the first request (block 710). The processing logic provides the first random number to the second cryptographic circuit in response to the second request (block 712), and the method 700 ends.

In at least one embodiment, the first random number is at least one of a mask, a nonce, a seed value, an IV, or a key-wrapping key. The first cryptographic circuit and the second cryptographic circuit can use the first random number in connection with DPA protection of cryptographic operations.

In a further embodiment, the processing logic receives, at the first time, a third request for a random number from a third cryptographic circuit. The processing logic determines that the third request is for a non-shared random number. The processing logic generates a second random number. The processing logic provides the second random number to the third cryptographic circuit in response to the third request.

In a further embodiment, the processing logic receives, receiving, at a second time, a third request for a non-shared random number from the first cryptographic circuit. The processing logic receives, at the second time, a fourth request for a non-shared random number from the second cryptographic circuit. The processing logic generates a second random number and a third random number. The processing logic provides the second random number to the first cryptographic circuit in response to the third request and provides the third random number to the second cryptographic circuit in response to the fourth request.

In a further embodiment, the processing logic receives, at a second time, a third request for a random number from the first cryptographic circuit over a direct connection between the entropy source and the first cryptographic circuit. The processing logic generates a second random number. The processing logic provides the second random number to the first cryptographic circuit only in response to the third request.

In a further embodiment, the processing logic receives, at a second time, a third request for a random number from the first cryptographic circuit over a direct connection between the entropy source and the first cryptographic circuit. The processing logic generates a second random number, and the processing logic only provides the second random number to the first cryptographic circuit in response to the third request.

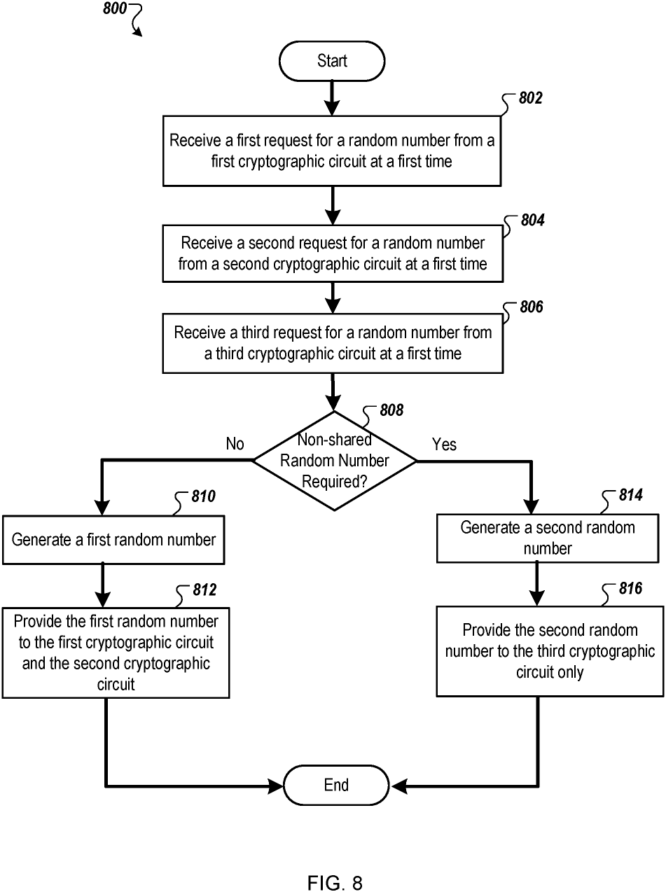

FIG. 8 is a flow diagram of a method 800 for selectively providing a shared random number to multiple cryptographic circuits and a non-shared random number to a single cryptographic circuit, according to at least one embodiment. The method 800 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 800 is performed by the random number generator 200 or 250 of FIGS. 2A or 2B. In one embodiment, the method 800 is performed by the entropy distribution logic 210 of FIGS. 2A, 2B, 5, or 6. In one embodiment, the method 800 is performed by entropy distribution logic 310 of FIG. 3 or the entropy distribution logic 410 of FIG. 4. In one embodiment, the method 800 is performed by entropy source 502 or integrated circuit 500 of FIG. 5. In one embodiment, the method 800 is performed by entropy source 602 or integrated circuit 600 of FIG. 6.

Referring to FIG. 8, the method 800 begins by the processing logic receiving, at a first time, a first request for a random number from a first cryptographic circuit (block 802). The processing logic receives, at the first time, a second request for a random number from a second cryptographic circuit (block 804). The processing logic receives, at the first time, a third request for a random number from a third cryptographic circuit (block 806). The processing logic determines whether a non-shared random number (e.g., a unique random number) is required for each of the requests received at the first time (block 808). The processing logic generates a first random number for requests that do not require a non-shared random number, e.g., the first and second requests and any other requests meeting this criterion (block 810). The processing logic provides the first random number to the first cryptographic circuit and the second cryptographic circuit (block 812). For the requests that do require a non-shared random number, e.g., the third request, the processing logic generates a second random number (block 814). It should be noted that a non-shared random number can be generated for each request meeting this criterion. The processing logic only provides the second random number to the third cryptographic circuit (block 816), and the method 800 ends.

In another embodiment, additional requests that do not require a non-shared random number can be received at the first time. The processing logic provides the first random number to the corresponding cryptographic circuits as well. Similarly, additional requests that require a non-shared random number can be received at the first time. The processing logic can generate a non-shared random number for each of these requests and provides the respective non-shared random number to only the corresponding cryptographic circuit.

In another embodiment, the processing logic receives a fourth request from the first cryptographic circuit that requires a non-shared random number at a second time. In this case, the processing logic generates a non-shared random number and provides it to the first cryptographic circuit in response to the fourth request. Similarly, the processing logic can receive, at the second time or at a third time, a fifth request from the third cryptographic circuit that does not require a non-shared random number. In this case, the processing logic generates a shared random number to provide to the third cryptographic circuit or provides a shared random number that has already been generated for other cryptographic circuits that can share the random number.

In some embodiments, when performing some operations, it can be necessary to use one or more arguments (e.g., key-wrapping keys, masks, entropy, IVs) that have a viable lifespan (time, usage count) limitation. This can be problematic when there is a real-time or high throughput requirement upon such operations. In such scenarios, a timely delivery mechanism is required to guarantee the delivery and usage of valid arguments.

Typically, such “fragile” data is delivered sequentially from the data source to each of its destinations. The transfer can include transmitting or delivering the data from the source to a single destination and waiting for an acknowledgment. Once the acknowledgment has been received, the source then commences the delivery of data to the next destination. The time required to complete all the transfers can potentially exceed the lifespan of the delivered data if there are many destinations or there is a delay in reception for one or more transfer acknowledgments. This has traditionally been addressed by introducing multiple timeout/retry timers and complicated scheduling logic to ensure timely completion of all the transfers and identify anomalous behavior.

In at least one embodiment, the situation can be improved by either broadcasting the data to all the destinations at once, similar to a multi-cast transmission in Ethernet. This can decouple the data delivery and acknowledgment without delaying the delivery of data by a previous destination’s delivery acknowledgment. These approaches can provide some following benefits, as well as others. Broadcasting the data to all destinations at once can remove any limit to the number of destinations that can be supported. The control logic can be simplified. For example, there can be a single time to track the lifespan of data and a single register to track delivery acknowledgment reception. In one embodiment, an incomplete delivery is simply indicated by the register not being fully populated by 1’s (or 0’s if the convention is reversed) at the end of the data timeout period.

It is to be understood that the above description is intended to be illustrative and not restrictive. Many other implementations will be apparent to those of skill in the art upon reading and understanding the above description. Therefore, the disclosure scope should be determined with reference to the appended claims, along with the full scope of equivalents to which such claims are entitled.

In the above description, numerous details are set forth. It will be apparent, however, to one skilled in the art that the aspects of the present disclosure may be practiced without these specific details. In some instances, well-known structures and devices are shown in block diagram form rather than in detail to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

However, it should be borne in mind that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “setting,” or the like, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems may be used with programs in accordance with the teachings herein, or it may prove convenient to construct more specialized apparatuses to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any procedure for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

What is claimed is:

1. An apparatus comprising:
a plurality of cryptographic circuits, wherein each of the plurality of cryptographic circuits is to receive a random number for differential power analysis (DPA) protection of a cryptographic operation, wherein at least two of the plurality of cryptographic circuits are configured to selectively use a same random number.

2. The apparatus of claim 1, further comprising:
a random number generator (RNG) operatively coupled to the plurality of cryptographic circuits, wherein the RNG is configured to selectively provide the same random number to the at least two of the plurality of cryptographic circuits.

3. The apparatus of claim 1, wherein the same random number is at least one of a mask, a nonce, a seed value, an initialization vector (IV), or a key.

4. The apparatus of claim 1, wherein a first cryptographic circuit of the plurality of cryptographic circuits is to send a request for a first random number, wherein the request comprises an indication that the first random number is shareable with other cryptographic circuits of the plurality of cryptographic circuits, the first random number being the same random number.

5. An apparatus comprising:
a random number generator (RNG) to generate random numbers; and
a plurality of cryptographic circuits operatively coupled to the RNG, wherein each of the plurality of cryptographic circuits is to receive a random number from the RNG, and wherein the RNG is configured to selectively provide a same random number to at least two of the plurality of cryptographic circuits.

6. The apparatus of claim 5, wherein the RNG is to:
receive a first request from a first cryptographic circuit of the plurality of cryptographic circuits;
receive a second request from a second cryptographic circuit of the plurality of cryptographic circuits;
generate a first random number; and
provide, at a first time, the first random number to the first cryptographic circuit and the second cryptographic circuit, the first random number being the same random number.

7. The apparatus of claim 6, wherein the RNG is further to:
receive a third request from a third cryptographic circuit of the plurality of cryptographic circuits; and
provide, at the first time, a second random number to the third cryptographic circuit, wherein the second random number and the first random number are different.

8. The apparatus of claim 6, wherein the RNG is further to:
receive a third request from the first cryptographic circuit of the plurality of cryptographic circuits;
receive a fourth request from the second cryptographic circuit of the plurality of cryptographic circuits;
generate a second random number;
generate a third random number; and
provide, at a second time, the second random number to the first cryptographic circuit and the third random number to the second cryptographic circuit, the second random number and the third random number being different.

9. The apparatus of claim 5, wherein the RNG is further to:
receive a first request for a first random number from a first cryptographic circuit of the plurality of cryptographic circuits, wherein the first request comprises an indication that the first random number is shareable with other cryptographic circuits of the plurality of cryptographic circuits;
generate the first random number; and
provide the first random number to the first cryptographic circuit, the first random number being the same random number.

10. The apparatus of claim 5, wherein the RNG is further to:
receive a first request for a first random number from a first cryptographic circuit of the plurality of cryptographic circuits, wherein the first request comprises an indication that the first random number is not shareable with other cryptographic circuits of the plurality of cryptographic circuits;
generate the first random number; and
provide the first random number to the first cryptographic circuit, wherein the first random number and the same random number are different.

11. The apparatus of claim 5, further comprising:
a first communication path between the RNG and a first cryptographic circuit of the plurality of cryptographic circuits;
a second communication path between the RNG and a second cryptographic circuit of the plurality of cryptographic circuits; and
a third communication path between the RNG and both the first cryptographic circuit and the second cryptographic circuit, wherein the RNG is to provide the same random number using the third communication path.

12. The apparatus of claim 11, wherein the third communication path is between the RNG and a third cryptographic circuit of the plurality of cryptographic circuits, wherein the first communication path and the second communication path are dedicated communication paths, and wherein the third cryptographic circuit does not include a dedicated communication path to the RNG.

13. The apparatus of claim 5, wherein the same random number is at least one of a mask, a nonce, a seed value, an initialization vector (IV), or a key, wherein each of the at least two of the plurality of cryptographic circuits is to use the same random number in connection with differential power analysis (DPA) protection of a cryptographic operation.

14. The apparatus of claim 5, wherein the RNG comprises:
a noise source;
a digitizer coupled to the noise source;
one or more accumulators coupled to the digitizer;
an control block coupled to the one or more accumulators; and
distribution logic coupled to the control block to receive an entropy output from the control block, wherein the distribution logic is to provide the entropy output as the same random number to the at least two of the plurality of cryptographic circuits.

15. A method of operating an entropy source, the method comprising:
receiving, at a first time, a first request for a random number from a first cryptographic circuit;
receiving, at the first time, a second request for a random number from a second cryptographic circuit;
generating a first random number;
providing the first random number to the first cryptographic circuit in response to the first request; and
providing the first random number to the second cryptographic circuit in response to the second request.

16. The method of claim 15, further comprising:
receiving, at the first time, a third request for a random number from a third cryptographic circuit;
determining that the third request is for a non-shared random number;
generating a second random number; and
providing the second random number to the third cryptographic circuit in response to the third request.

17. The method of claim 15, further comprising:
receiving, at a second time, a third request for a random number from the first cryptographic circuit;
receiving, at the second time, a fourth request for a random number from the second cryptographic circuit;
generating a second random number;
generating a third random number;
providing the second random number to the first cryptographic circuit in response to the third request; and
providing the third random number to the second cryptographic circuit in response to the fourth request.

18. The method of claim 15, further comprising:
receiving, at a second time, a third request for a random number from the first cryptographic circuit;
determining that the third request comprises an indication that the random number be a non-shared random number;
generating a second random number; and
providing the second random number to the first cryptographic circuit in response to the third request.

19. The method of claim 15, further comprising:
receiving, at a second time, a third request for a random number from the first cryptographic circuit over a direct connection between the entropy source and the first cryptographic circuit;
generating a second random number; and
providing the second random number to the first cryptographic circuit only in response to the third request.

20. The method of claim 15, wherein the first random number is at least one of a mask, a nonce, a seed value, an initialization vector (IV), or a key-wrapping key, wherein each of the first cryptographic circuit and the second cryptographic circuit is to use the first random number in connection with differential power analysis (DPA) protection of a cryptographic operation.
